(19) United States
(12) Patent Application Publication
(10) Pub. No.: US 2003/0216943 A1
(43) Pub. Date: Nov. 20, 2003

(54) Interactive system and method for collecting and reporting health and fitness data

(76) Inventors: Ron McPhee, Albuquerque, NM (US); Jeff Collins, Albuquerque, NM (US); Robert Montenegro, Albuquerque, NM (US)

Correspondence Address: HOFFMANN & BARON, LLP, 6900 JERICHO TURNPIKE, SYOSSET, NY, 11791, US

(21) Appl. No.: 10/146,721

(22) Filed: May 15, 2002

(51) Int. Cl. G06F 17/60

(52) U.S. Cl. 705/3

(57) ABSTRACT

A system and method concurrently collects, submits, stores, processes, accesses, and reports demographic, health, and fitness data associated with students in a physical education program. The data is collected from the students and stored in access centers at various levels including a class, school, district, state, national, regional, and international level. Access to the stored data is provided via the Internet to users having different access rights, restrictions, and privileges at various levels including a student, parent, teacher, school official, district official or agency, national/regional official or agency, and international official or agency level. A third party server may intervene in the submission, storage, access to, and reporting of data via the Internet. The system and method is also intended for use with individuals in the armed services, police departments, fire departments, and corporations.

### COPYRIGHT NOTICE

A portion of the disclosure of this document contains material that is subject to copyright protection. The copyright owner has no objection to the facsimile reproduction of the patent disclosure, as it appears in the U.S. Patent and Trademark Office patent files or records, but otherwise reserves all copyright rights whatsoever.

### BACKGROUND OF THE INVENTION

1. Field of the Invention

The present invention relates generally to collecting and reporting demographic, health, and fitness data associated with individuals in large groups, and more particularly to an interactive web-based system for concurrently collecting, submitting, analyzing, and reporting this data to a variety of users ranging from the individuals to international officials and agencies having different access restrictions.

2. Description of the Related Art

Each year an increasing number of teenage athletes die from cardiac arrest while training for competitive sports. Across the nation, school-age children suffer from these and other previously undetected health problems while engaging in a standard physical education program.

In the past, the focus in physical education has been on athletic skills and team sports rather than on a fitness program that could be individually tailored to the particular needs and abilities of each student. In most cases, traditional physical education curriculum benefits only about 30% of its participants while leaving the rest with bad memories and demeaning experiences, such as being picked last for the team or ridiculed by instructors and peers for being too weak or slow.

Moreover, the athletic skills critical in team sports often leave students ill equipped to maintain physical fitness beyond adolescence when, as an adult, an abundance of time and others of similar age and skill are no longer as readily available. As obesity becomes epidemic and the general health of young people deteriorates nationwide, parents and educators have been forced to view physical education from a new perspective—that of the individual.

Thus, the trend in physical education is away from team-based sports, which are typically dominated by a minority of student with natural athletic ability, towards participation by all students in fitness programs tailored to parameters, such as heart rate, which reflect the differences in size, strength, and body composition of each student. With the advent of this new curriculum, a method of tracking and reporting the progress of each student and comparing this progress with other similarly situated students and groups of students becomes vital.

Standardized tests for academic skills, such as math and English, have been used for decades to monitor progress and correct deficiencies in these areas. However, an interactive method for tracking the health and fitness of students representing various demographics and efficiently reporting this information has not yet been developed. For such a system to be useful, it must be readily available to a variety of users without violating privacy concerns of individuals involved in the program.

U.S. Pat. No. 5,435,315, which is incorporated herein by reference, discloses a method and apparatus for determining the physical fitness of an individual. Data associated with blood pressure, heart rate, energy expenditure, isometric strength, flexibility, and body composition is input to the device, which then calculates a value representing the overall fitness of the individual. However, this system does not provide a way to collect large quantities of this information and make it interactively available to users with different access rights and restrictions.

It is an object of the present invention to provide a system and method for collecting demographic, health, and fitness data associated with students and storing this data at class, school, district, state, national, regional, and international levels that are coupled via the Internet, telecommunication links, and the like.

It is a further object of the present invention to provide a system and method that enables interactive access to and reporting of student demographic, health, and fitness data to students, parents, teachers, school officials, and district, state, national, regional, and international officials and agencies having various access rights and restrictions in a secure manner without violating privacy issues.

It is still a further object of the present invention to provide a system and method for concurrently collecting, storing, and reporting demographic, health, and fitness data associated with individuals in relatively large groups, such as the armed services, corporations, police departments, fire departments, and schools.

It is yet a further object of the present invention to provide a system and method that enables interactive access to and reporting of student demographic, health, and fitness and international officials and agencies via the Internet.

It is another object of the present invention to provide a system and method for concurrently collecting, storing, and reporting demographic, health, and fitness data associated with students, which enables information to be input from ancillary databases, such as family income, for correlation with the demographic, health, and fitness data.

It is still another object of the present invention to provide a system and method wherein a third party server acts as an intermediary or gateway in the concurrent collection, storage, and reporting of student demographic, health, and fitness data from a class, school, district, state, regional, national, and international level to students, parents, teachers, school officials, and district, state, national, regional, and international officials and agencies via the Internet

### SUMMARY OF THE INVENTION

These and other goals and objectives of the present invention provide a method of concurrent submission, storage, and access to health and fitness data, which includes the steps of collecting demographic data, health data, and fitness data associated with a plurality of individuals, submitting the collected data interactively to an access center, and storing the submitted data interactively at the access center. The method also determines whether a user has sufficient access rights and provides interactive access to and reporting of the stored data via the Internet in response to the user having the appropriate access rights.

The present invention also provides a system for concurrent submission, storage, and access to health and fitness data, which includes a plurality of storage medium and a computing device. The storage medium are located at access centers and are operatively coupled to the Internet. The computing device is operatively coupled to the storage medium and operates in accordance with software. The computing device prompts interactive submission to the access center of the demographic data, health data, and fitness data collected from a plurality of individuals and interactively stores this data in the storage medium. The computing device determines whether a user has sufficient access rights and provides interactive access to and reporting of the stored data via the Internet in response to the user having the appropriate access rights.

These and other objects, features, and advantages of this invention will become apparent from the following detailed description of illustrative embodiments thereof, which is to be read in connection with the accompanying drawings.

### BRIEF DESCRIPTION OF THE DRAWINGS

FIG. 1 is a block diagram of an interactive system formed in accordance with the present invention for concurrently collecting, submitting, storing, analyzing, and reporting demographic, health, and fitness data of students.

FIG. 2 is a high-level flowchart showing the operation of a method formed in accordance with the present invention for concurrently collecting, submitting, storing, analyzing, and reporting demographic, health, and fitness data of students.

FIG. 3 is a flowchart showing further detail concerning the collection of demographic, health, and fitness data shown in FIG. 2.

FIG. 4 is a flowchart showing further detail concerning the submission of demographic, health, and fitness data shown in FIG. 2.

FIG. 5 is a block diagram showing the preferred paths for data submission between access centers shown in FIG. 1.

FIG. 6 is a flowchart showing further detail concerning the interactive access to and report generation of demographic, health, and fitness data shown in FIG. 2.

FIG. 7 shows a screen for registration of the user, which is preferably displayed on a user terminal.

FIG. 8 shows a screen for login of the user displayed on the user terminal.

FIG. 9 shows a screen providing district contact information for display on the user terminal.

FIG. 10 shows a screen providing school contact information for display on the user terminal.

FIG. 11 shows a state report at a district level for display on the user terminal.

FIG. 12 shows a state report at a school level for display on the user terminal.

FIG. 13 shows a custom report for display on the user terminal.

FIG. 14 shows a status report of a particular school for display on the user terminal.

FIG. 15 is a flowchart showing data flow, report generation, and management in a preferred application of the method formed in accordance with the present invention.

FIG. 16 shows a screen showing a status report for a particular school for display on the user terminal

FIG. 17 shows a screen on the user terminal, which enables the user to upload demographic data.

FIG. 18 shows a screen that enables the user to correct demographic data.

FIG. 19 shows a screen that enables the user to initiate an upload of demographic data.

FIG. 20 shows a screen that indicates that health and fitness data has been downloaded for access by the user.

FIG. 21 shows a reminder e-mail for display on the user terminal that requests the user to upload demographic data.

### DETAILED DESCRIPTION OF THE PREFERRED EMBODIMENTS

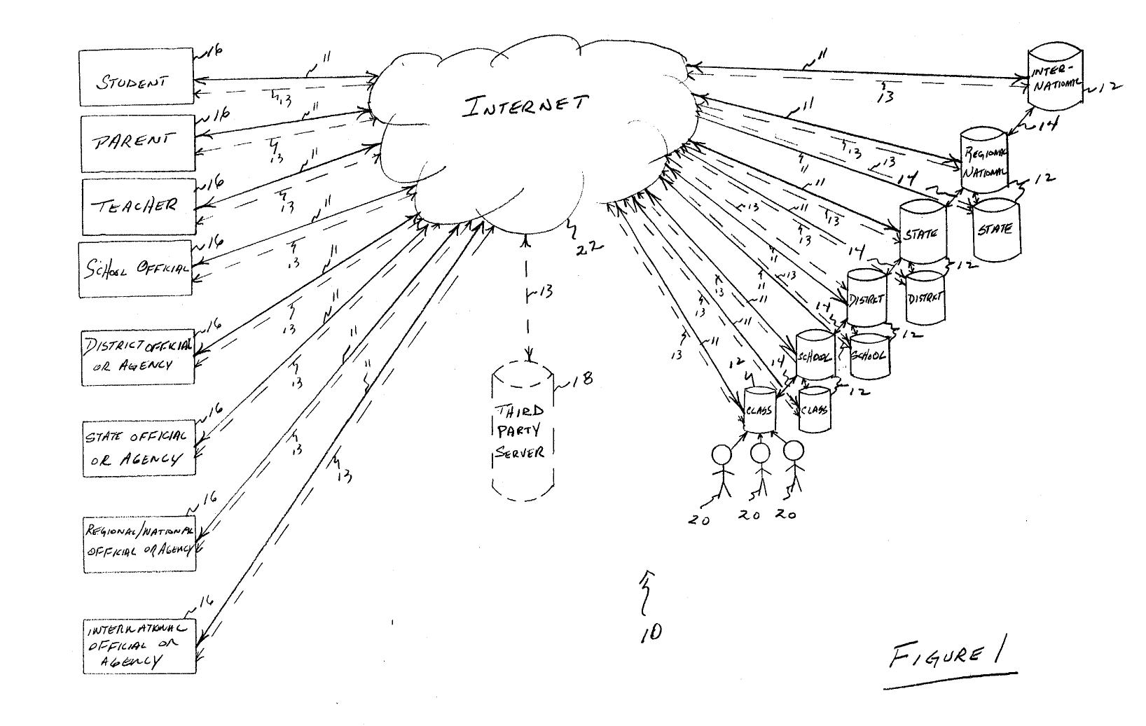

FIG. 1 is a block diagram of an interactive system 10 formed in accordance with the present invention for concurrently collecting, submitting, storing, analyzing, and reporting demographic, health, and fitness data associated with students. The system 10 includes storage medium that are preferably located in various access centers 12. The access centers 12 are preferably associated with different levels including a class, school, district, state, regional, national, and international level. The access centers 12 are operatively coupled to each other via the Internet 22, telecommunication links 14, or similar communication links.

As shown by the solid arrows 11 in FIG. 1, the system 10 preferably provides interactive access via the Internet 22 to data stored at the access centers 12 for users at different levels, such as student, parent, teacher, school official, district official or agency, state official or agency, regional/national official or agency, and international official or agency. It is anticipated that the user preferably accesses the Internet 22 using a personal computer, user 16 terminal, or the like.

The system 10 may also include a third-party server 18, which preferably acts as an intermediary website or gateway between the various levels of user 16 and the different access centers 12, as shown by the dotted lines 13 in FIG. 1. The third party server 18 is preferably linked to the storage medium at the access centers 12 via the Internet 22 and controls access by the user 16 terminals and data report generation from the access centers 12. The user 16 terminals preferably access the third-party server 18 by selecting a particular website, such as healthyschools.net.

Essentially, in the preferred embodiment, demographic, health, and fitness data is collected from students 20 and stored in storage medium at the corresponding class access center 12. This data may then be further processed and submitted up the chain of access centers 12 via the Internet 22 or telecommunication links 14 for storage, processing, access by, and reporting to various levels of user 16 terminals via the Internet 22.

In a first embodiment, as represented by the solid lines 11 in FIG. 1, the various levels of users 16 are preferably able to access information stored at one or more of the access centers 12 directly via the Internet 22. Thus, in the first embodiment, an access center 12 being accessed by the user 16, such as the district access center 12, would preferably include a web server, mainframe computer, computing device, or a comparable system or device.

In a second embodiment, as represented by the dashed lines 13 in FIG. 1, the various levels of users 16 preferably access information stored at one or more of the access centers 12 indirectly through the third party server 18 via the Internet 22. Thus, in the second embodiment the third party server 18, which acts as an intermediary website between the user and the access centers, is directly accessed by the user 16 and preferably includes a web server, mainframe computer, computing device, or the like.

It is anticipated that the demographic information preferably includes the student's name, address, date of birth, teacher, period, graduating year, race, religion, physical handicap code, mental handicap code, gender, the number of parents in the student's household, and the like. Similarly, it is anticipated that the fitness and health data preferably includes information associated with heart disease, diabetes, cancer, stress, depression, nutrition, safety habits, violence, drug habits, alcohol habits, heart rate, blood pressure, cholesterol levels, triglyceride levels, blood glucose levels, girth, circumference, body mass index, skin fold measurements, cardiovascular performance, aerobic capacity, strength, flexibility, body composition, Body Age™, overall fitness, and other such parameters.

The storage medium, which are preferably located at the access centers 12, store current and historical demographic, health, and fitness data associated with each of the students 20. For instance, data stored at the school access center 12 may include the ranking of each student with respect to a specific health or fitness parameter or a combination of parameters, such as overall fitness.

Likewise, data stored at the district access center 12 may include a consolidation of the databases stored at school access centers 12, which are located within the district, into a common district database. The district database is preferably used to compare, analyze trends, and rank all access centers 12 at or below the district level, such as comparing one school with another school, comparing one school with the district, comparing a class to its school, and comparing a class to its district.

In the system 10 formed in accordance with the present invention, various restrictions, privileges, and access rights are preferably assigned to each user lever 16, and may be reassigned at any time. For instance, at the student user level the user is preferably able to self-report health and fitness data and access any personal data associated with the particular student being granted access to the system 10.

At the teacher user level, the teacher is preferably able to access information associated with the particular teacher's students. At the parent user level, the parent is preferably able to access information associated with the particular parent's child or children.

At the district user level, the district official or agency is preferably able to view summary and detailed student information associated with the accessing district, other districts, and a state summary, but is preferably not given access to detailed information concerning a particular student. Likewise, a state official or agency is preferably able to access information concerning the state, district, and schools within that state, without being able to access particular information concerning a student to avoid violating privacy concerns.

At the school level, individual student assessment reports and teacher class reports are preferably generated with an ability for the school official or agency to perform a group report. The individual assessment reports preferably indicate the fitness levels of students with personal recommendations for improvement. Information available at the school level preferably also includes a student ranking report concerning one or more health or fitness parameters and a fitness quotient, which indicates an overall fitness level.

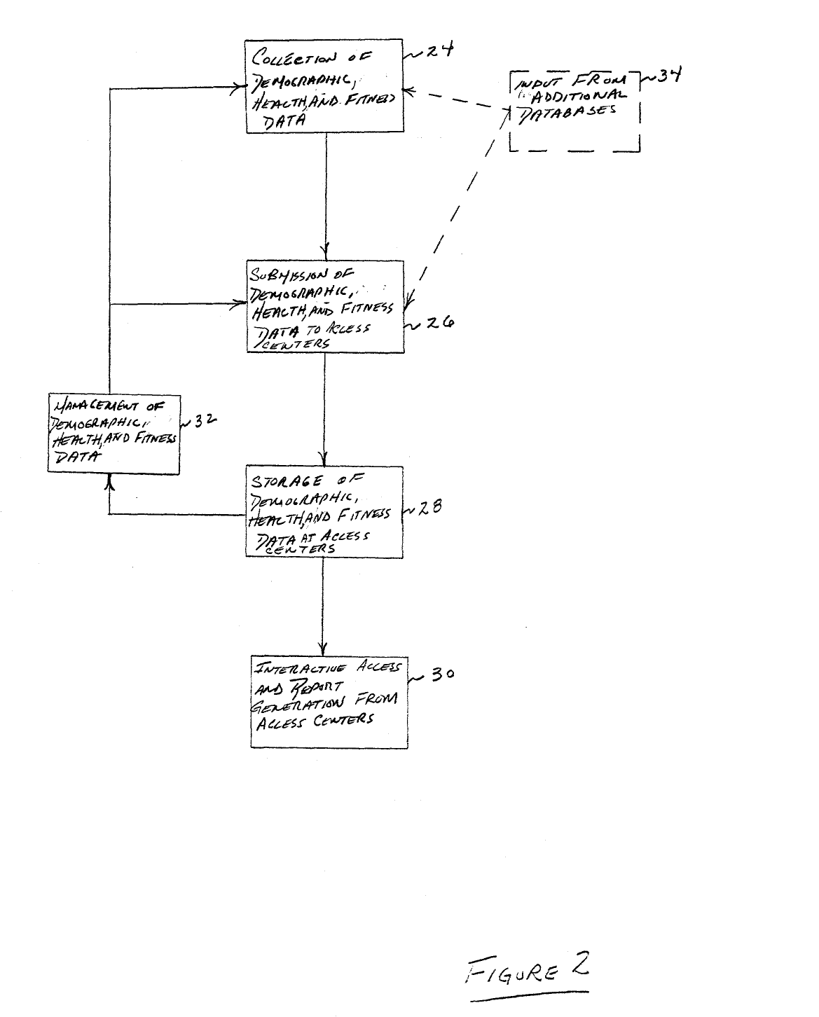

FIG. 2 is a high-level flow chart showing the operation of a method formed in accordance with the present invention, which is preferably performed by the third party server, as described above with respect to the second embodiment, or similar hardware and software located at one or more of the access centers, as described above with respect to the first embodiment. Demographic, health, and fitness data is preferably collected from the students in step 24, and this data is submitted to the access centers in step 26. Submission of data to the access centers in step 26 includes submission of the collected student information to the class access center, as well as submission of this data and further processed forms of this data up the chain of access centers via the Internet, telecommunication links, which may be alternatively or complementarily coordinated by the third-party server, as described with respect to the second embodiment and represented by the dashed lines 13 in FIG. 1.

It is important to note that demographic, health, and fitness data is collected in step 24, submitted in step 26, stored in step 28, interactive access is granted and reports are generated in step 30 concurrently and substantially simultaneously by implementing the system and method in accordance with the present invention using a plurality of processing units within the third party server or computing device. The access centers and/or the third party server are preferably capable of managing the collection and submission of data via step 32 by, for instance, transmitting reminder emails to access centers requesting further submission of data. Data from additional databases, such as family income, may be input during the collection and submission of demographic, health, and fitness data in step 34 for correlation with the student information.

FIG. 3 is a flow chart showing further detail concerning the step of collecting demographic, health, and fitness data 24 shown in FIG. 2. In step 36, demographic data is preferably collected from the students by an administrator, such as the students' teacher. Alternatively, the demographic data may be collected in step 37 from self-reporting questionnaires, which are completed by the students.

Information collected in step 36 is preferably input by the administrator in step 15 and information collected in step 37 is preferably input by reading a Scantron™ form, optical character recognition (OCR), or the like in step 15 and stored in at least a temporary storage medium in step 17. The collected data is preferably interactively displayed in step 19 and revised, if necessary, in step 21 prior to being stored in step 17.

As indicated above, the demographic information preferably includes the student's name, address, date of birth, teacher, period, graduating year, race, religion, physical handicap code, gender, mental handicap code, number of parents in the student's household, and the like. In step 38, a health-risk appraisal self reporting questionnaire is preferably administered to the students, which includes information associated with heart disease, diabetes, cancer, stress, depression, nutrition, safety habits, preventions habits, violence, drug habits, and alcohol habits, and other relevant information.

The information from the questionnaire is preferably input in step 23 by reading a Scantron™ form, optical character recognition (OCR), or other input devices and methods and stored in at least a temporary storage medium in step 25. The collected health risk data is preferably interactively displayed in step 27 and revised, if necessary, in step 29 prior to being stored in step 25.

Physical data associated with the student is preferably measured in step 40. The physical data preferably includes heart rate, blood pressure, cholesterol levels, triglyceride levels, glucose levels, girth, circumference, body mass index, skin fold measurements, cardiovascular performance, aerobic capacity, strength, flexibility, body composition, Body Age™, and overall fitness. The physical data is preferably collected by using a comprehensive physical fitness evaluation system or method, such as that disclosed in U.S. Pat. No. 5,435,315, which is incorporated herein by reference.

Body Age™ refers to a proprietary compilation (also known as Wellness Age™, which is a copyright protected method of HealthFirst Corporation) including at least four assessments, two of which preferably include strength, flexibility, cardiovascular performance, or body composition assessments. The remaining two assessments are preferably chosen from the following:

1. Systolic blood pressure;

2. Diastolic blood pressure;

3. Total Cholesterol level;

4. HDL level;

5. LDL level;

6. Heart Disease assessment;

7. Lung Cancer assessment;

8. Colon Cancer assessment;

9. Skin Cancer assessment;

10. Breast Cancer assessment;

11. Cervical Cancer assessment;

12. Diabetes assessment;

13. Stress assessment;

14. Depression assessment;

15 Nutrition assessment;

16. Safety habit assessment;

17 Prevention assessment;

18. Body Composition;

19. Cardiovascular performance;

20. Flexibility; and

21. Strength.

If the student performs more than one flexibility test, a modified sit-and-reach is preferably used to calculate Body Age™. For example, if the user performs a shoulder rotation and a modified sit-and-reach assessment, only the modified sit-and-reach will be used to calculate Body Age™.

If the student performs more than one strength test, an on-line biceps strength test is preferably used to calculate Body Age™. For example, if the user performs a maximum pushup assessment and an on-line biceps strength assessment, only the modified sit-and-reach is preferably used to calculate Body Age™.

Referring again to FIG. 3, the measured physical data is preferably input in step 31 and stored in at least a temporary storage medium in step 33. The measured physical data is preferably interactively displayed in step 35 and revised, if necessary, in step 37 prior to being stored in step 33.

The demographic, health, and fitness data is processed and/or analyzed in step 42, during which data from additional databases, such as family income, may be input in step 34 and correlated with the collected data. A record including the demographic, health, and fitness data is then preferably created for storage in step 46. However, prior to storage, the new or updated demographic, health, and fitness data is preferably interactively displayed in step 39 and outputted in step 41 to, for instance, a printer (not shown).

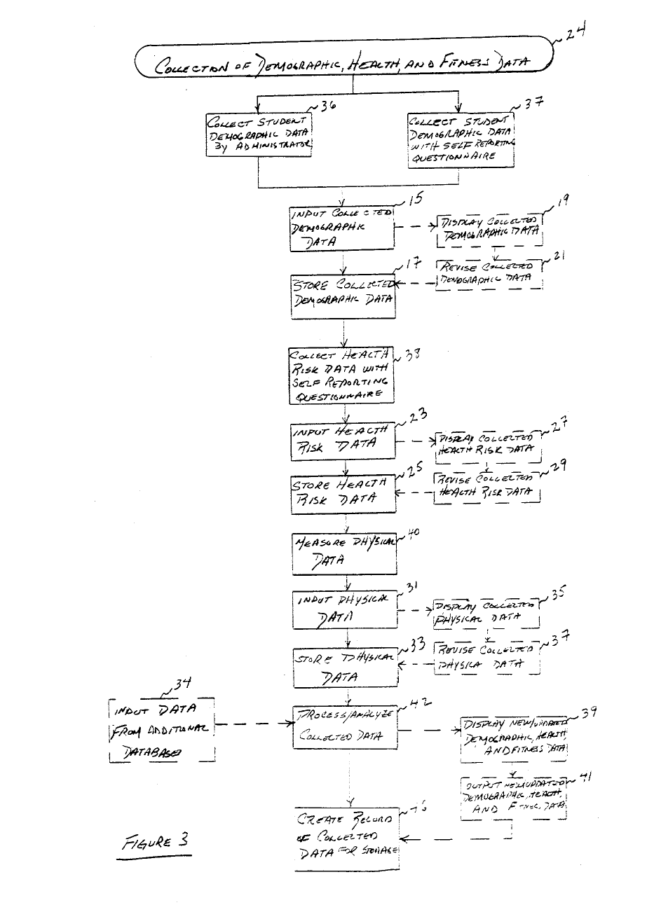

FIG. 4 is a flow chart showing further detail concerning the submission of demographic, health, and fitness data, which is also shown as step 26 in FIG. 2. The submission of data preferably follows either a server initiated data submission path (pull) via step 48 or a client initiated data submission path (push) via step 50.

In the server initiated data submission path, the access center (first embodiment) or third party server (second embodiment) preferably issues a reminder e-mail requesting an upload of status, demographic, health, or fitness data from another access center in step 52. The requested access center then preferably submits data to the third party server or requesting access center via the Internet, telecommunication link, or other communication links in step 54.

Prior to submitting the data in step 54, the submitted data is preferably interactively displayed to the user for verification in step 43 and revised, if necessary, in step 45. The submitted data is processed and/or analyzed at the access center or third party server in step 56. Data may also be input from additional databases, such as family income in step 34 for correlation with the submitted data.

If the submission of data follows the client initiated data submission path, status, demographic, or health/fitness data is submitted via the Internet, telecommunication link, removal medium (such as a compact disk), mail, fax, or the like in step 62. Prior to submitting the data in step 62, the submitted data is preferably interactively displayed to the user for verification in step 47 and revised in step 49, if necessary.

The submitted data is preferably processed and/or analyzed in step 56 and, if the user has the appropriate submission rights in step 51, the data is stored at the access center in step 28. If the user does not have the appropriate submission rights in step 51, a submission error is displayed in step 53 and the method preferably returns to step 56.

Data from additional databases may be input in step 34 for correlation with the data submitted via the client initiated data submission path. Prior to storing the submitted data in step 28, existing demographic, health, and fitness data is preferably interactively displayed to the user for verification in step 57, if the user has the appropriate access rights in step 55, and revised in step 60, if necessary.

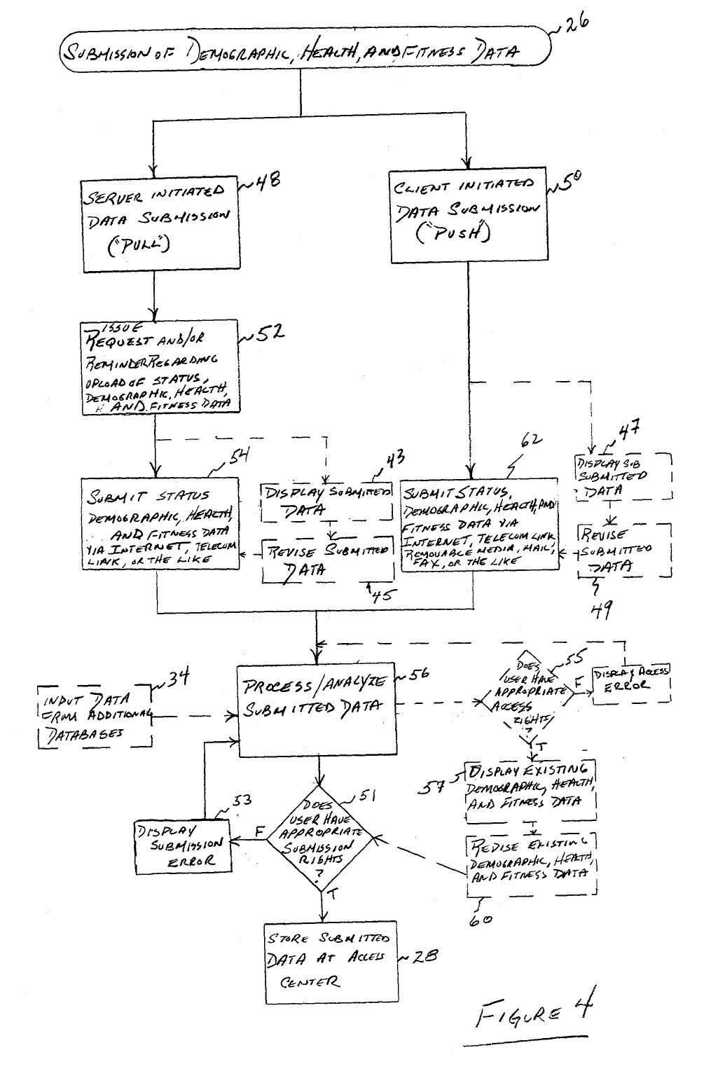

FIG. 5 is a block diagram showing the preferred paths for data submission between the access centers shown in FIG. 1. For instance, the student access center 12 is preferably able to submit data to any of the higher-level access centers 12, which include the class, school, district, state, regional/national, and international access centers 12, without requiring submission of the data to an intervening access center 12 between the student access center 12 and the access center 12 that is the ultimate destination of the submitted data. The submission paths are preferably implemented via the Internet or shared/dedicated telecommunication links coupling the access centers 12.

FIG. 6 is a flow chart showing further detail concerning the interactive access and report generation step 30, which is also shown as step 30 in FIG. 2. In step 64, the method requires new users to input registration information in step 66, such as the name of a particular school or district and the name, address, and e-mail address of a contact person for the chosen school and district.

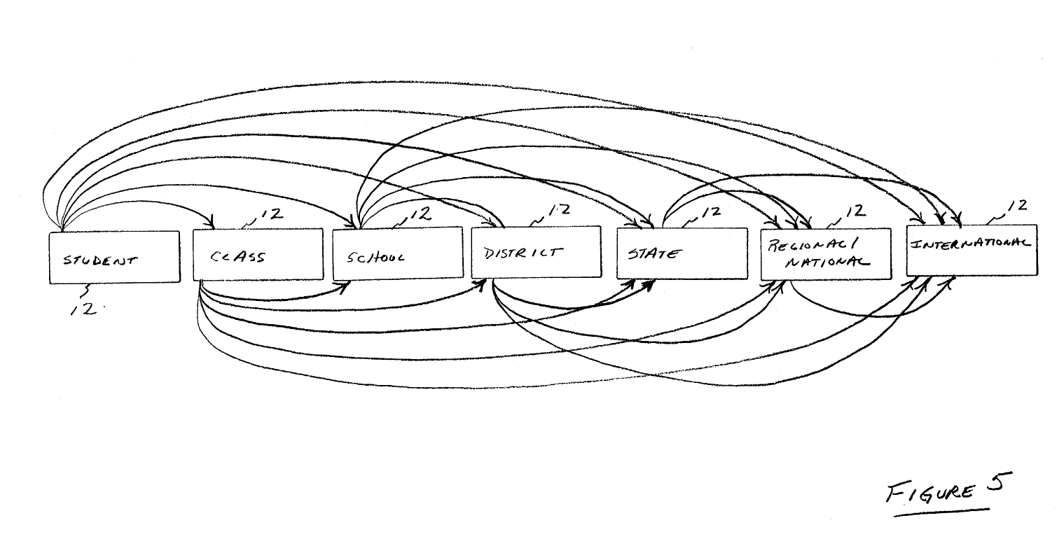

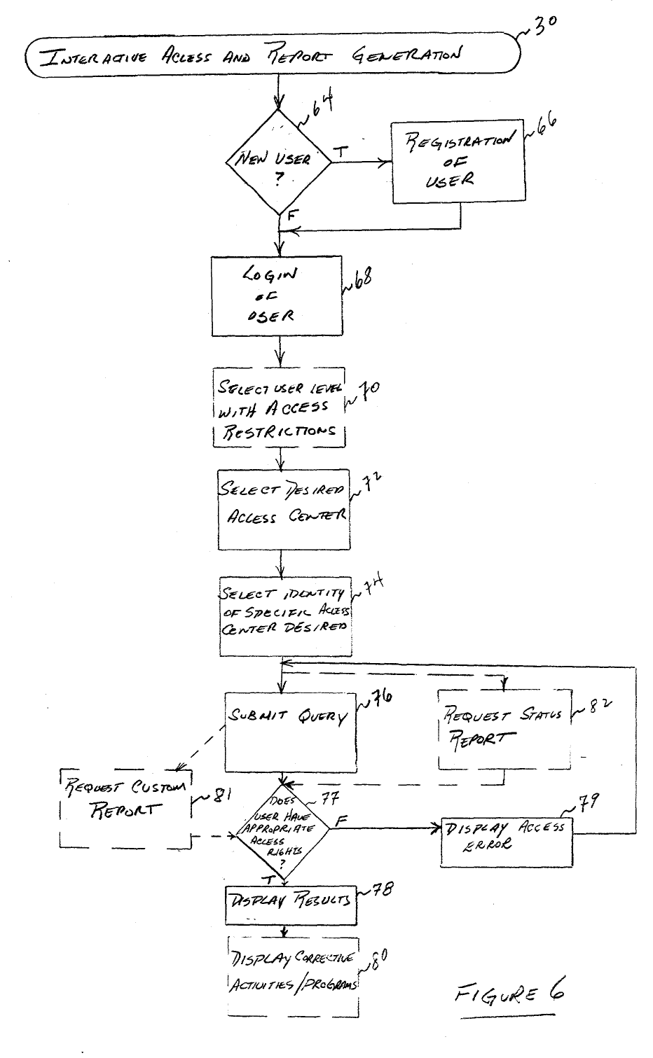

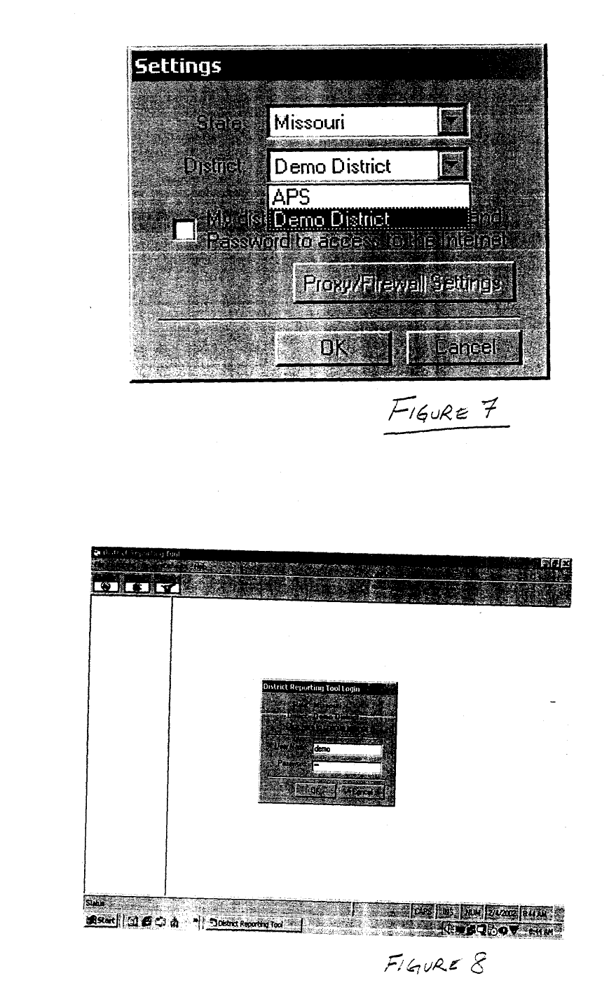

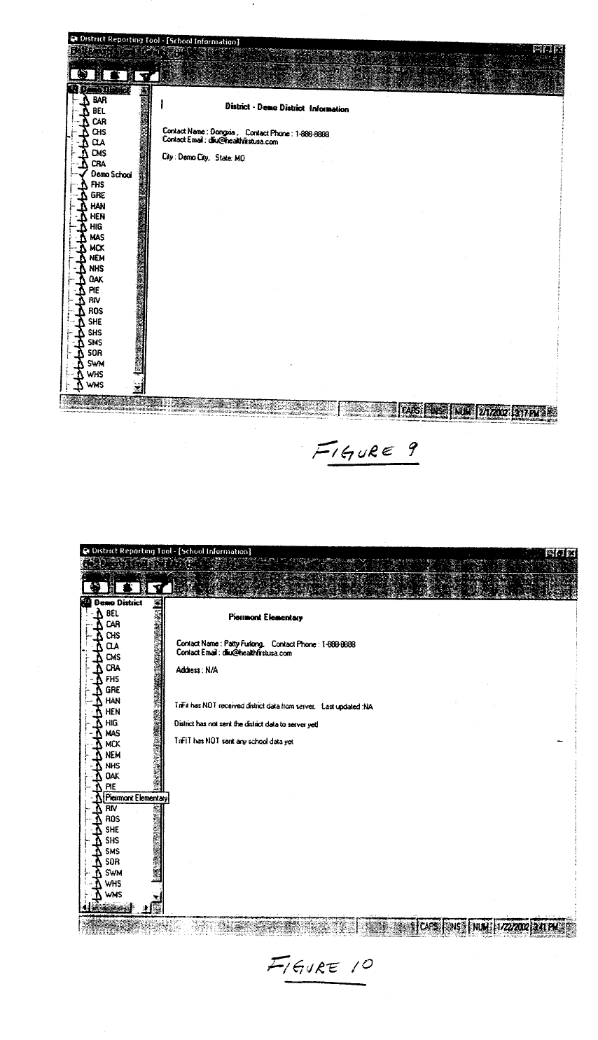

The new user also preferably selects a state and district during the registration process. If a particular district requires that the username and password be submitted in order to grant access to the Internet, the user must also preferably select proxy and firewall settings. FIG. 7 shows a screen that is preferably displayed on a user terminal, which enables the user to select the state, district, and proxy or firewall settings.

Referring again to FIG. 6, the user preferably submits a login sequence that includes the username and password in step 68. The username and password may be chosen by the user or randomly generated by the system. FIG. 8 shows a screen, which is preferably displayed at the user terminal that enables entry of the username and password.

As shown in FIG. 6, the user may select a user level, such as student, parent, teacher, school official, school agency, district official, district agency, or the like in step 70. Various access rights, restrictions, and privileges are preferably associated with the selected user level. The user level may also be automatically selected in response to input of the login sequence. The user preferably selects an access center in step 72, such as school, and provides the identity of the specific access center chosen in step 74, such as Piermont Elementary School, as shown in FIG. 10.

Once the login procedure is successfully completed, the user is preferably able to access contact information concerning the desired district, as shown in FIG. 9, by selecting a particular district from a list of districts displayed in a left field of the screen. Similarly, the user may obtain contact information concerning a desired school, as shown in FIG. 10, by selecting a particular school in the left field of another screen preferably displayed on the user terminal.

Referring again to FIG. 6, the user preferably submits a query in step 76 and, if the user has sufficient or appropriate access rights as determined in step 77, the results of the query are displayed in step 78. However, if the user does not have appropriate access rights in step 77, an access error is preferably displayed in step 79 and the method prompts the user for another query in step 76. Typical queries include the following:

1. What is the frequency of obese students that remain obese?

2. Compare physical education Program A to physical education Program B body fat trends over the last five years.

3. Compare average income levels to average body fat percentage.

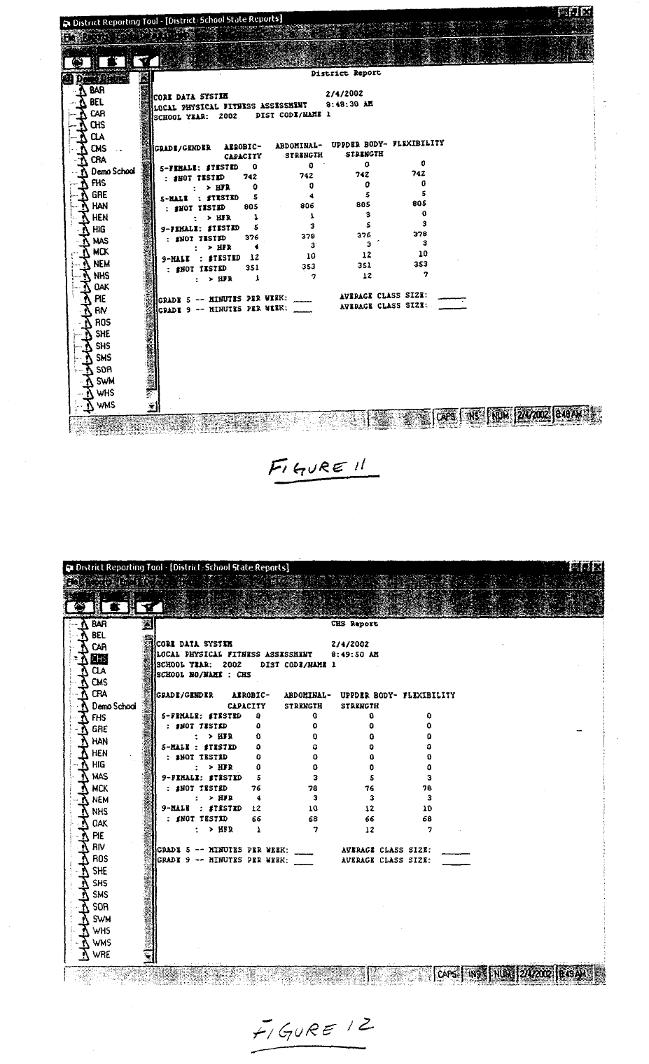

Queries may also request, for instance, a state report at the district level, as shown in FIG. 11, or a state report at the school level, as shown in FIG. 12. Alternatively, the user may request a custom report, as shown in FIG. 13, which preferably enables the displayed data to be sorted and analyzed by date range, grade, gender, and age in step 81 of FIG. 6.

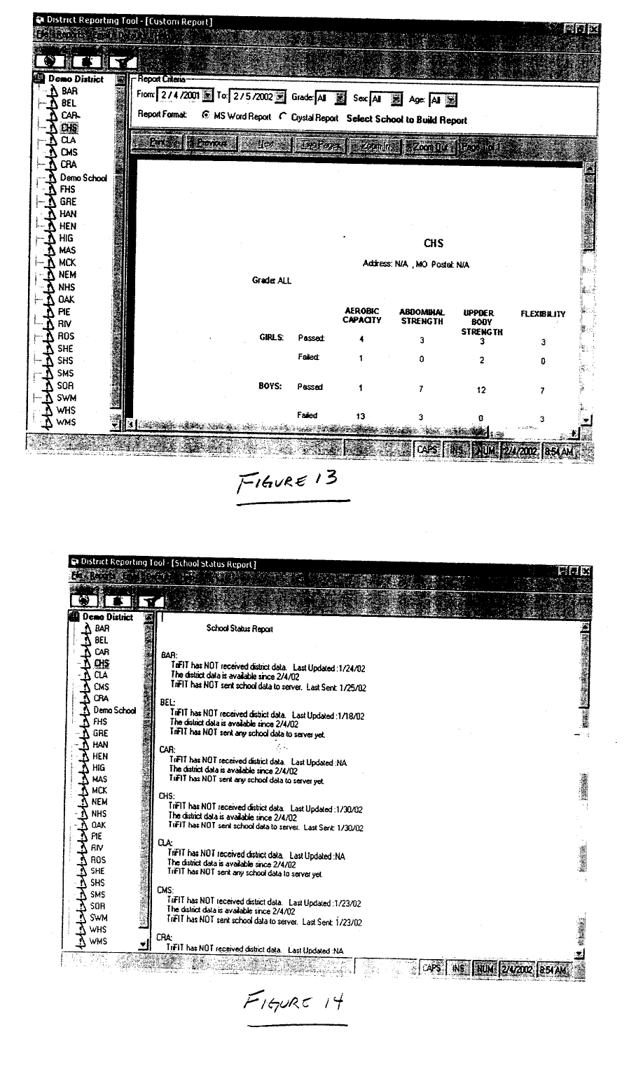

The user may also request a status report in step 82, an example of which is shown in FIG. 14. The status report preferably displays the status for each school concerning the currency or validity of stored data concerning that school, such as whether the school has received a new student list, or whether the school has submitted fitness data to an access center. Referring to FIG. 6, the system preferably displays, in step 80, corrective activities, programs, goals, warning signs, risk factors, symptoms, and recommendations associated with the results displayed in step 78 in graphical or textual form.

FIG. 15 is a flow chart showing data flow, report generation, and management sequences in a preferred application of the method formed in accordance with present invention. The district official or agency preferably submits demographic data to the third-party server in step 82.

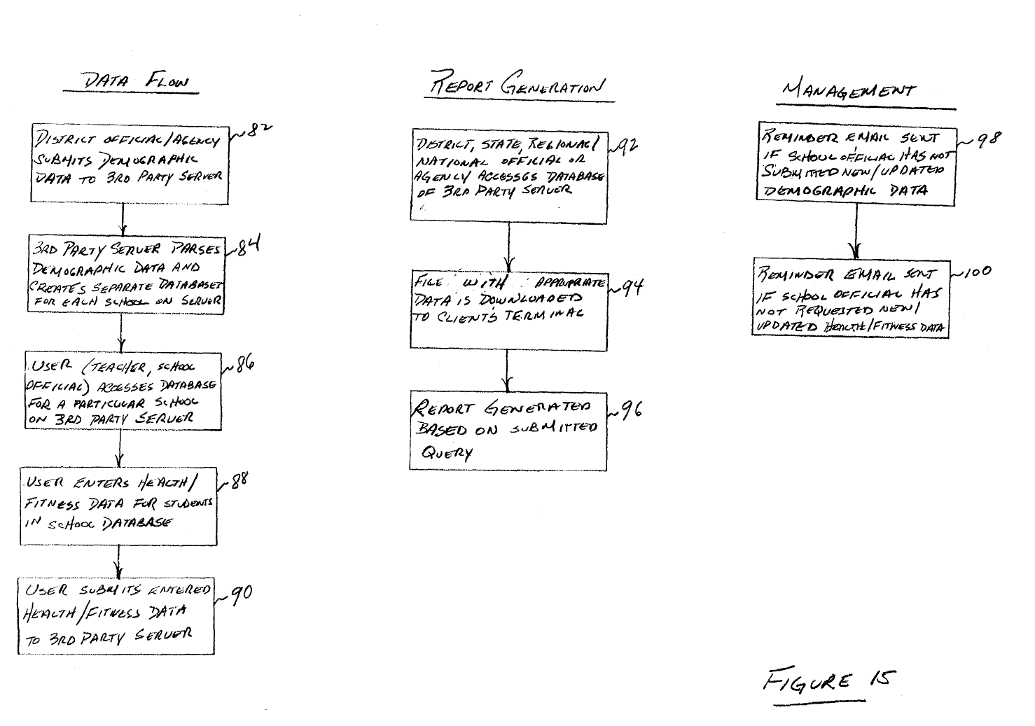

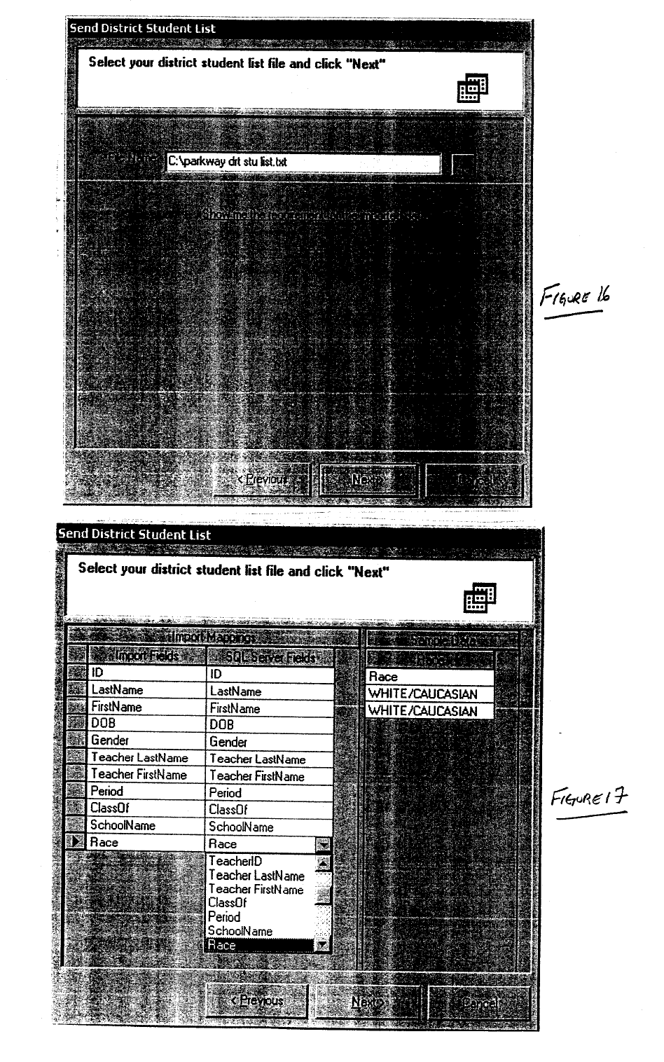

FIG. 16 shows a screen preferably displayed at the user terminal, which enables the upload of demographic data concerning students in a district by selecting a so-called “send district student list” function, which requests that the user input the identity of the district for which demographic data is being uploaded. The district official then preferably maps the fields required for upload of the demographic information, as shown in FIG. 17.

The third-party server preferably parses the demographic data in step 84, as shown in FIG. 15. If there are any errors, these errors will be highlighted on the user terminal, as shown on the screen in FIG. 18, which enables the user to select and correct the error.

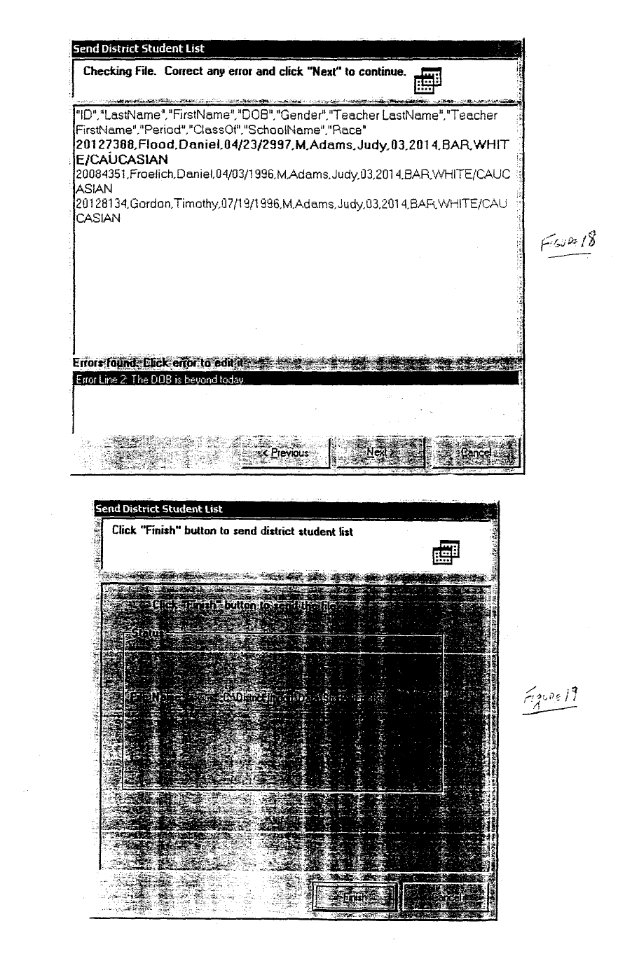

If the data is formatted correctly, the user is preferably prompted to select “Finish”, as shown in FIG. 19, to enable submission of the student demographic data to the third-party server. As shown in FIG. 15, the third-party server then preferably generates separate databases for each school on the server in step 84.

The user preferably accesses the database for a particular school on the third-party server in step 86 and enters health and fitness data for each student in the school database in step 88. When entry of the data is complete, the user preferably submits the completed database to the third-party server in step 90.

During the report generation sequence shown in FIG. 15, the district, state, regional or national official or agency preferably accesses the databases via the third-party server in step 92, which downloads the appropriate data to the user terminal in step 94. A report is then generated in step 96, which is based on the query submitted by the user and the database downloaded in step 94.

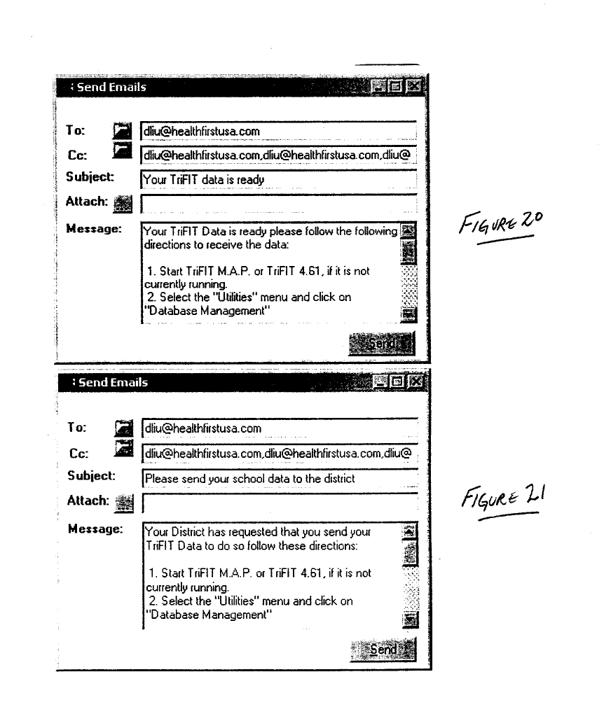

In order to manage the submission of data, a reminder e-mail is preferably transmitted to school officials periodically or at regular intervals when new or updated demographic data or health/fitness data has not been provided by the school, as shown in steps 98 and 100. FIG. 20 shows a reminder e-mail that is preferably displayed on the user terminal to indicate that health and fitness data is ready to be downloaded to the user. FIG. 21 shows a reminder e-mail that is preferably displayed on the user terminal, which indicates that demographic data should be uploaded to the access center.

The system formed in accordance with the present invention has been described in detail as applied to a student-based physical education program, but could alternatively or supplementarily be applied to individuals in the armed services, police departments, fire departments, and corporations while remaining within the scope of the present invention.

Therefore, the method and system formed in accordance with the present invention collects demographic, health, and fitness data associated with students and concurrently stores this data at class, school, district, state, national, regional, and international levels, which are coupled via the Internet, telecommunication links, and the like. The system and method also enable interactive access and reporting of student demographic, health, and fitness data to students, parents, teachers, school officials, and district, state, national, regional, and international officials and agencies having various access rights and restrictions in a secure manner without violating privacy issues. Further, the system and method enable information to be input from ancillary databases, such as family income, for correlation with the demographic, health, and fitness data.

Although the illustrative embodiments of the present invention have been described herein with reference to the accompanying drawings, it is to be understood that the invention is not limited to those precise embodiments and that various other changes and modifications may be effected therein by one skilled in the art without departing from the scope or spirit of the invention.

What is claimed is:

1. A method of providing concurrent submission, storage, and access to health and fitness data, the method including the steps of:
collecting demographic data and at least one of health data and fitness data associated with a plurality of individuals;
submitting the collected data interactively to an access center;
storing the submitted data interactively at the access center;
determining whether a user has sufficient access rights; and
providing interactive access to the stored data via the Internet in response to the user having sufficient access rights.

2. A method of providing concurrent submission, storage, and access to health and fitness data as defined by claim 1, the method further comprising the steps of:
inputting a query from the user; and
generating a report representative of the stored data in response to the query and the user having sufficient access rights.

3. A method of providing concurrent submission, storage, and access to health and fitness data as defined by claim 1, wherein the data stored at the access center is associated with at least one of a class, school, district, state, national, regional, and international level.

4. A method of providing concurrent submission, storage, and access to health and fitness data as defined by claim 1, wherein the user is at least one of a student, teacher, parent, school official, district official, district agency, state official, state agency, national official, national agency, regional official, regional agency, international official, and international agency.

5. A method of providing concurrent submission, storage, and access to health and fitness data as defined by claim 1, wherein the individual is a member of at least one of a school, armed service, police department, fire department, and corporation.

6. A method of providing concurrent submission, storage, and access to health and fitness data as defined by claim 1, wherein the step of submitting the collected data to an access center further comprises the steps of:
submitting the collected data to a third party server; and
transferring the collected data from the third party server to the access center.

7. A method of providing concurrent submission, storage, and access to health and fitness data as defined by claim 1, wherein the step of providing interactive access to a user further comprises the steps of:
accessing a third party server by the user; and
providing interactive access to the stored data by the third party server to the user.

8. A method of providing concurrent submission, storage, and access to health and fitness data as defined by claim 2, wherein the step of generating a report representative of the stored data further comprises the steps of:
accessing a third party server by the user; and
generating the report interactively by the third party server.

9. A method of providing concurrent submission, storage, and access to health and fitness data as defined by claim 1, further comprising the step of prompting at least one of the collection and submission of at least one of demographic data, health data, and fitness data by issuing reminders to the access center via e-mail.

10. A method of providing concurrent submission, storage, and access to health and fitness data as defined by claim 1, wherein the step of collecting further includes the steps of:
collecting demographic data associated with an individual;
inputting the collected demographic data interactively;
storing the collected demographic data;
collecting health risk data associated with the individual from a self reporting questionnaire administered to the individual;
inputting the health risk data interactively;
storing the health risk data;
measuring physical data associated with the individual;
inputting the physical data interactively;
storing the physical data; and
generating a record for storage including at least one of the demographic data, health risk data, and physical data associated with the individual.

11. A method of providing concurrent submission, storage, and access to health and fitness data as defined by claim 10, wherein the step of collecting demographic data further includes at least one of the steps of entering the demographic information by an administrator and self reporting the demographic information by the individual.

12. A method of providing concurrent submission, storage, and access to health and fitness data as defined by claim 1, further comprising the step of performing at least one of processing and analyzing the collected data.

13. A method of providing concurrent submission, storage, and access to health and fitness data as defined by claim 12, further comprising the steps of:
inputting data from an additional database; and
correlating the data input from the additional database with the collected data in the step of performing at least one of processing and analyzing the collected data.

14. A method of providing concurrent submission, storage, and access to health and fitness data as defined by claim 10, wherein the demographic data includes at least one of name, address, date of birth, teacher, period, graduating year, race, religion, physical handicap code, mental handicap code, gender, number of parents in the individual's household.

15. A method of providing concurrent submission, storage, and access to health and fitness data as defined by claim 10, wherein the health risk data includes information associated with at least one of heart disease, diabetes, cancer, stress, depression, nutrition, safety habits, prevention habits, violence, drug habits, and alcohol habits.

16. A method of providing concurrent submission, storage, and access to health and fitness data as defined by claim 10, wherein the physical data includes information associated with at least one of heart rate, blood pressure, cholesterol level, triglyceride level, blood glucose level, girth, circumference, body mass index, skin fold measurements, cardiovascular performance, aerobic capacity, strength, flexibility, body composition, Body Age™, and overall fitness.

17. A method of providing concurrent submission, storage, and access to health and fitness data as defined by claim 1, wherein the step of submitting further includes the step of submitting at least one of demographic data, health data, and fitness data via at least one of the Internet and a telecommunication link to the access center.

18. A method of providing concurrent submission, storage, and access to health and fitness data as defined by claim 1, wherein the step of submitting further includes the step of performing at least one of processing and analyzing the submitted data.

19. A method of providing concurrent submission, storage, and access to health and fitness data as defined by claim 18, further comprising the steps of:
inputting data from an additional database; and
correlating the data input from the additional database with the submitted data in the step of performing at least one of processing and analyzing the submitted data.

20. A method of providing concurrent submission, storage, and access to health and fitness data as defined by claim 1, wherein the step of submitting further includes the step of submitting data from the access center associated with a member of a set of levels including student, class, school, district, state, national, regional, and international to the access center associated with at least one of a subsequent member of the set of levels including student, class, school, district, state, national, regional, and international.

21. A method of providing concurrent submission, storage, and access to health and fitness data as defined by claim 1, wherein the step of providing interactive access further includes the steps of:
inputting a login sequence from the user;
determining whether the input login sequence is valid;
denying access to the user in response to the input login sequence being invalid inputting an access center type selected by the user;
inputting an identification of the access center selected by the user for access;
inputting a query from the user;
determining whether the user has sufficient access rights; and
outputting the results of the query via the Internet in response to the user having sufficient access rights.

22. A method of providing concurrent submission, storage, and access to health and fitness data as defined by claim 21, further comprising the step of identifying a new user by inputting registration information associated with the new user.

23. A method of providing concurrent submission, storage, and access to health and fitness data as defined by claim 21, wherein the step of inputting a query further includes the step of inputting a request for a custom report, the custom report sorting the results of the query by at least one of date range, grade, gender, and age.

24. A method of providing concurrent submission, storage, and access to health and fitness data as defined by claim 21, wherein the step of outputting the results of the query further includes the step of displaying at least one of a corrective activity, program, goal, warning sign, risk factor, symptom, and recommendation associated with results of the query.

25. A method of providing concurrent submission, storage, and access to health and fitness data as defined by claim 21, wherein the step of inputting a query further includes the step of inputting a request for a status report, the status report providing information representing the currency of at least one of demographic, health, and fitness data stored at the access center.

26. A method of providing concurrent submission, storage, and access to health and fitness data as defined by claim 1, wherein the step of submitting the collected data interactively to an access center further includes the steps of:
submitting demographic data from at least one of an individual and an access center to a third party server via the Internet;
parsing the demographic data by the third party server;
generating a database associated with the demographic data by the third party server;
downloading the database generated by the third party server to the access center;
entering at least one of health data and fitness data into the database;
uploading the database from the access center to the third party server;
downloading the database in response to a request for interactive access by the user; and
generating a report representative of the downloaded data in response to a query from the user.

27. A system for providing concurrent submission, storage, and access to health and fitness data comprising:
a plurality of storage medium, the storage medium being located at an access center, the storage medium being operatively coupled to the Internet;
a computing device operatively coupled to the storage medium, the computing device operating in accordance with software, the computing device including a plurality of processing units that enable concurrent execution of tasks within the computing device, the computing device prompting interactive submission to the access center of at least one of demographic data, health data, and fitness data collected from a plurality of individuals, the computing device interactively storing at least one of the demographic data, health data, and fitness data in the plurality of storage medium, the computing device determining whether a user has sufficient access rights, the computing device providing interactive access to the stored data via the Internet in response to the user having sufficient access rights.

28. A system for providing concurrent submission, storage, and access to health and fitness data as defined by claim 27, wherein the computing device generates a report in response a query input from the user and the user having sufficient access rights.

29. A system for providing concurrent submission, storage, and access to health and fitness data as defined by claim 27, wherein the data stored in the plurality of storage medium is associated with at least one of a class, school, district, state, national, regional, and international level.

30. A system for providing concurrent submission, storage, and access to health and fitness data as defined by claim 27, wherein the user is at least one of a student, teacher, parent, school official, district official, district agency, state official, state agency, national official, national agency, regional official, regional agency, international official, and international agency.

31. A system for providing concurrent submission, storage, and access to health and fitness data as defined by claim 27, wherein the individual is a member of at least one of a school, armed service, police department, fire department, and corporation.

32. A system for providing concurrent submission, storage, and access to health and fitness data as defined by claim 27, wherein the computing device includes a third party server.

33. A system for providing concurrent submission, storage, and access to health and fitness data as defined by claim 27, wherein the computing device is located at the access center.

34. A system for providing concurrent submission, storage, and access to health and fitness data as defined by claim 27, wherein the computing device issues a reminder via email to the access centers regarding the collection and submission of least one of demographic data, health data, and fitness data.

35. A system for providing concurrent submission, storage, and access to health and fitness data as defined by claim 27, wherein the computing device inputs and stores demographic data associated with an individual, the computing device inputting and storing health risk data from a self reporting questionnaire administered to the individual, the computing device inputting and storing physical data associated with the individual, the computing device generating a record including at least one of the demographic data, health risk data, and physical data associated with the individual for storage.

36. A system for providing concurrent submission, storage, and access to health and fitness data as defined by claim 27, wherein the computing device inputs data from an additional database and correlates the data from the additional database with the collected data.

37. A system for providing concurrent submission, storage, and access to health and fitness data as defined by claim 35, wherein the demographic data includes at least one of name, address, date of birth, teacher, period, graduating year, race, religion, physical handicap code, mental handicap code, gender, and number of parents in the individual's household.

38. A system for providing concurrent submission, storage, and access to health and fitness data as defined by claim 35, wherein the health risk data includes information associated with at least one of heart disease, diabetes, cancer, stress, depression, nutrition, safety habits, prevention habits, violence, drug habits, and alcohol habits.

39. A system for providing concurrent submission, storage, and access to health and fitness data as defined by claim 35, wherein the physical data includes information associated with at least one of heart rate, blood pressure, cholesterol level, triglyceride level, blood glucose level, girth, circumference, body mass index, skin fold measurements, cardiovascular performance, aerobic capacity, strength, flexibility, body composition, Body Age™, and overall fitness.

40. A system for providing concurrent submission, storage, and access to health and fitness data as defined by claim 27, wherein the computing device submits at least one of demographic data, health data, and fitness data via at least one of the Internet, a telecommunication link, removable medium, mail, and facsimile to the plurality of storage medium.

41. A system for providing concurrent submission, storage, and access to health and fitness data as defined by claim 27, wherein the computing device inputs data from an additional database and correlates the data input from the additional database with the submitted data.

42. A system for providing concurrent submission, storage, and access to health and fitness data as defined by claim 27, wherein the computing device transfers data from the access center associated with a member of a set of levels including student, class, school, district, state, national, regional, and international to the access center associated with at least one of a subsequent member of the set of levels including student, class, school, district, state, national, regional, and international.

43. A system for providing concurrent submission, storage, and access to health and fitness data as defined by claim 27, wherein the computing device inputs a login sequence from the user and determines whether the input login sequence is valid, the computing device denying access to the user in response to the input login sequence being invalid, the computing device inputting an access center type selected by the user, the computing device inputting an identification of the access center selected by the user for access and inputting a query from the user, the computing device determining whether the user has sufficient access rights and outputting the results of the query via the Internet in response to the user having sufficient access rights.

44. A system for providing concurrent submission, storage, and access to health and fitness data as defined by claim 43, wherein the computing device identifies a new user by inputting registration information associated with the new user.

45. A system for providing concurrent submission, storage, and access to health and fitness data as defined by claim 43, wherein the computing device inputs a request for a custom report from the user, the custom report sorting the results of the query by at least one of date range, grade, gender, and age.

46. A system for providing concurrent submission, storage, and access to health and fitness data as defined by claim 43, wherein the computing device displays at least one of a corrective activity, program, goal, warning sign, risk factor, symptom, and recommendation associated with the results of the query.

47. A system for providing concurrent submission, storage, and access to health and fitness data as defined by claim 43, wherein the computing device inputs a request for a status report from the user, the status report providing information concerning the currency of health and fitness data stored at the access center.

48. A system for providing concurrent submission, storage, and access to health and fitness data as defined by claim 27, wherein the computing device includes a third party server, the demographic data being submitted from the access center to the third party server via the Internet, the third party server parsing the demographic data, the third party server generating a database associated with the demographic data and downloading the database to the access center, the access center entering at least one of health data and fitness data into the database, the access center uploading the database including the entered at least one of health data and fitness data to the third party server, the third party server downloading the database in response to a query from the user, the third party server generating a report representative of the downloaded data in response to the query.

49. A system for providing concurrent submission, storage, and access to health and fitness data as defined by claim 27, wherein the plurality of access centers are operatively coupled by at least one telecommunication link.

50. A system for providing concurrent submission, storage, and access to health and fitness data as defined by claim 27, wherein the computing device is located at the access center.
